(19) United States
(12) Patent Application Publication
(10) Pub. No.: US 2026/0159043 A1
(43) Pub. Date: Jun. 11, 2026

(54) High Pressure Sensor Cleaning Nozzles

(71) Applicant: Aurora Operations, Inc., Pittsburgh, PA (US)

(72) Inventors: Curtis Robert Barry Lambert, Pittsburgh, PA (US); Danyang Li, Wexford, PA (US); Jon Robert Torrey, San Francisco, CA (US)

(21) Appl. No.: 18/980,677

(22) Filed: Dec. 13, 2024

Related U.S. Application Data
(60) Provisional application No. 63/610,927, filed on Dec. 15, 2023.

(51) Int. Cl. B60S 1/56; B60S 1/52

(52) U.S. Cl. CPC B60S 1/56; B60S 1/52

(57) ABSTRACT

A sensor cleaning system for an autonomous vehicle includes at least one sensor configured to generate a sensor signal. The at least one sensor includes at least one sensor lens. At least one reservoir for a fluid and at least one conduit fluidly coupled to the at least one reservoir and to at least one nozzle are configured to direct the fluid towards the sensor lens. At least one processor is communicatively coupled to the at least one sensor. A memory is operably coupled with the at least one processor, where the memory stores instructions that cause the at least one processor to perform operations including: receiving the sensor signal from the sensor; comparing a detected quality of the sensor signal relative to a nominal quality of the sensor signal; and, dispensing the fluid from the at least one reservoir through the nozzle towards the sensor lens.

### REFERENCE TO EARLIER FILED APPLICATIONS

The present application is a U.S. Non-Provisional patent application and claims priority to and the benefit of U.S. Provisional Patent Application Ser. No. 63/610,927 filed Dec. 15, 2023 and titled High Pressure Sensor Cleaning Nozzles, the disclosure of which is incorporated in its entirety by this reference.

### BACKGROUND

Vehicles of every type, particularly semi-autonomous or fully autonomous cars, trucks, and the like, often rely upon a variety of sensors mounted on an exterior of the vehicle. These sensors provide relevant information for various assemblies and control systems. For example, cameras, SONAR, and LIDAR (Light Detection and Ranging) sensors may be used to detect road conditions, obstacles, and other data that may then be used in various algorithms.

These sensors, by virtue of being positioned on the exterior of the vehicle, may be exposed to environmental conditions such as snow, rain, dust, dirt and mud, and other hazards that may degrade or impair the performance of the sensor. Consequently, there exists a need to clean such sensors of any obstructive material to ensure the sensors operate at their nominal capability.

### SUMMARY

The present disclosure describes a sensor cleaning system for use on an autonomous vehicle includes at least one sensor configured to generate a sensor signal. The at least one sensor includes a sensor bottom; a sensor top spaced apart from the sensor bottom; and at least one sensor lens configured to provide a field of view extending away from an exterior of the autonomous vehicle, wherein the at least one sensor lens includes a circumference and a radius of curvature. The system also includes at least one reservoir for a fluid; at least one conduit fluidly coupled to the at least one reservoir and to at least one nozzle configured to direct the fluid towards the at least one sensor lens; at least one processor communicatively coupled to the at least one sensor; and, a memory operably coupled with the at least one processor, where the memory stores instructions that, in response to execution of the instructions by the at least one processor, cause the at least one processor to perform operations including: receiving the sensor signal from the at least one sensor; comparing a detected quality of the sensor signal relative to a nominal quality of the sensor signal; and, dispensing the fluid from the at least one reservoir through the at least one nozzle towards the at least one sensor lens.

Other implementations of one or more of these aspects include corresponding systems, apparatus, and computer programs, configured to perform the actions of the methods, encoded on computer storage devices.

These and other implementations may each optionally include one or more of the following aspects. The at least one sensor may be one of a wide-angle view camera sensor, a camera sensor, a fish-eye camera sensor, and an infrared sensor. The at least one sensor may provide at least a 120-degree field of view.

Optionally, the fluid may be one of a) a gas at a pressure above atmospheric pressure and b) a liquid.

The at least one nozzle optionally includes a nozzle angle, wherein the nozzle angle is measured relative to a vertical axis and relative to a horizontal axis, and wherein the nozzle angle is at least one of a) tilted away from the vertical axis and towards the sensor face and b) tilted towards the horizontal axis. The at least one nozzle may include an exit with a shape of one of a circle, a slot, a square, a rectangle, and an oval. The at least one nozzle may be positioned proximate at least one of the sensor bottom, the sensor top, the sensor left side, and the sensor right side. The at least one nozzle may extend approximately 180 degrees around the at least one sensor lens.

The at least one nozzle may include a plurality of nozzles. A first nozzle of the plurality of nozzles optionally dispenses a liquid and a second nozzle of the plurality of the nozzles optionally dispenses a gas.

The at least one reservoir may include a plurality of reservoirs.

The at least one conduit may include a plurality of conduits, where the at least one nozzle may include a plurality of nozzles, and where a first conduit of the plurality of conduits is fluidly coupled to a first reservoir of the plurality of reservoirs and to a first nozzle of the plurality of nozzles and a second conduit of the plurality of the conduits is fluidly coupled to a second reservoir of the plurality of reservoirs and to a second nozzle of the plurality of nozzles.

The at least one cleaning system may include at least one pump fluidly coupled to the at least one reservoir and the at least one conduit, the at least one pump being communicatively coupled to the at least one processor. The memory optionally may store instructions that, in response to execution of the instructions by the at least one processor, cause the at least one processor to perform operations including: generating and transmitting a pump signal to the at least one pump; and, actuating the at least one pump.

The at least one cleaning system may include at least one valve fluidly coupled to the at least one reservoir and the at least one conduit, the at least one valve being communicatively coupled to the at least one processor. The memory may store instructions that, in response to execution of the instructions by the at least one processor, cause the at least one processor to perform operations including: generating and transmitting a valve signal to the at least one valve; and, actuating the at least one valve.

A vehicle may include any one or more of the foregoing elements of the sensor cleaning system in any combination as described above. For brevity, all potential elements and combinations are not redescribed here. As one example, a vehicle may include a power train; at least one sensor configured to generate a sensor signal. The at least one sensor includes a sensor bottom; a sensor top spaced apart from the sensor bottom; and at least one sensor lens configured to provide a field of view extending away from an exterior of the autonomous vehicle, wherein the at least one sensor lens includes a circumference and a radius of curvature. The vehicle may also include at least one reservoir for a fluid; at least one conduit fluidly coupled to the at least one reservoir and to at least one nozzle configured to a direct the fluid towards the at least one sensor lens; and a vehicle control system that may include: at least one processor communicatively coupled to the at least one sensor; and, a memory operably coupled with the at least one processor, where the memory stores instructions that, in response to execution of the instructions by the at least one processor, cause the at least one processor to perform operations including: receiving the sensor signal from the at least one sensor; comparing a detected quality of the sensor signal relative to a nominal quality of the sensor signal; and, dispensing the fluid from the at least one reservoir through the at least one nozzle towards the at least one sensor lens.

Optionally, the vehicle control system may provide one of full control and semi-autonomous control over the vehicle. The vehicle may be a truck.

A vehicle control system for a vehicle may include any one or more of the foregoing elements of the sensor cleaning system in any combination as described above. For brevity, all potential elements and combinations are not redescribed here. As one example, a vehicle control system for a vehicle may include a sensor cleaning system for use on the vehicle with at least one sensor configured to generate a sensor signal. The at least one sensor includes a sensor bottom; a sensor top spaced apart from the sensor bottom; and at least one sensor lens configured to provide a field of view extending away from an exterior of the autonomous vehicle, wherein the at least one sensor lens includes a circumference and a radius of curvature. The system also includes at least one reservoir for a fluid; at least one conduit fluidly coupled to the at least one reservoir and to at least one nozzle configured to a direct the fluid towards the at least one sensor lens; at least one processor communicatively coupled to the at least one sensor; and, a memory operably coupled with the at least one processor, where the memory stores instructions that, in response to execution of the instructions by the at least one processor, cause the at least one processor to perform operations including: receiving the sensor signal from the at least one sensor; comparing a detected quality of the sensor signal relative to a nominal quality of the sensor signal; and, dispensing the fluid from the at least one reservoir through the at least one nozzle towards the at least one sensor lens.

This specification also relates to methods of cleaning a sensor on a vehicle. The method may be implemented by the sensor cleaning system and/or the vehicle control system as described above and below. The method may include at least one sensor configured to generate a sensor signal. The at least one sensor includes a sensor bottom; a sensor top spaced apart from the sensor bottom; and at least one sensor lens configured to provide a field of view extending away from an exterior of the autonomous vehicle, wherein the at least one sensor lens includes a circumference and a radius of curvature. The method may also include at least one reservoir for a fluid; at least one conduit fluidly coupled to the at least one reservoir and to at least one nozzle configured to a direct the fluid towards the at least one sensor lens. The method may also include a vehicle control system that includes: at least one processor communicatively coupled to the at least one sensor; and, a memory operably coupled with the at least one processor, where the memory stores instructions that, in response to execution of the instructions by the at least one processor, cause the at least one processor to perform one or more of the following operations implemented in any order, including: receiving the sensor signal from the at least one sensor; comparing a detected quality of the sensor signal relative to a nominal quality of the sensor signal; and, dispensing the fluid from the reservoir through the at least one nozzle towards the at least one sensor lens.

The method may also include repeating the receiving operation, the comparing operation, and the dispensing operation until one of a) the detected quality of the sensor signal is within the nominal quality of the sensor signal from the at least one sensor or b) a selected number of dispensing operations occurs within a selected period of time.

### BRIEF DESCRIPTION OF THE DRAWINGS

These and other aspects and features of the present implementations will become apparent upon review of the following description of specific implementations in conjunction with the accompanying figures, wherein:

FIG. 1 is a block diagram illustrating an example hardware and software environment for an autonomous vehicle according to some implementations.

FIG. 2 is a block diagram illustrating an example computing system for the sensor cleaning system according to some implementations.

FIG. 3 is a flow chart illustrating a method of cleaning a sensor according to some implementations.

FIG. 4 illustrates a front view of a sensor cleaning system according to some implementations.

FIG. 5 illustrates a perspective view of the sensor cleaning system of FIG. 4.

FIGS. 6A and 6B illustrate a top perspective view and a bottom perspective view of another sensor cleaning system according to some implementations.

FIG. 7 illustrate a close up of another sensor cleaning system according to some implementations.

FIG. 8 illustrates a perspective view of the sensor cleaning system of FIG. 7.

FIG. 9 illustrates an in-use view of the sensor cleaning system of FIG. 7.

FIG. 10 illustrates a top view of sensor cleaning system according to some implementations.

FIG. 11 illustrates an in-use view of another sensor cleaning system according to some implementations.

FIG. 12 illustrates a perspective view of another sensor cleaning system according to some implementations.

FIG. 13 illustrates a perspective view of another sensor cleaning system according to some implementations.

FIG. 14 illustrates a perspective view of another sensor cleaning system according to some implementations.

FIGS. 15A and 15B illustrate an implementation of at least one nozzle of a sensor cleaning system.

### DETAILED DESCRIPTION

### Overview

As mentioned, vehicles of every type, particularly semi-autonomous or fully autonomous cars, trucks, and the like, often rely upon a variety of sensors mounted on an exterior of the vehicle. These sensors provide relevant information for various assemblies and control systems. For example, cameras, SONAR, and LIDAR (Light Detection and Ranging) sensors may be used to detect road conditions, obstacles, and other data that may then be used in various algorithms.

These sensors, by virtue of being positioned on the exterior of the vehicle, may be exposed to environmental conditions such as snow, rain, dust, dirt and mud, and other hazards that may degrade or impair the performance of the sensor.

Historically, an operator of a vehicle might observe conditions that lead to reduced visibility of say a windshield. Of course, an autonomous vehicle may not have an operator present to observe and initiate a cleaning cycle.

Autonomous vehicles, therefore, might be equipped with a sensor cleaning system that is capable of detecting or observing sensor data that suggest the sensor is perhaps at least partially occluded by snow, rain, dirt, debris, or another condition that might be improved by initiating a cleaning cycle. A cleaning cycle, once initiated by on-board processors or a remote operation or data center, might improve the likelihood that the sensor is operating nominally or as close to nominally as is reasonably possible given the environmental conditions.

### Autonomous Vehicle

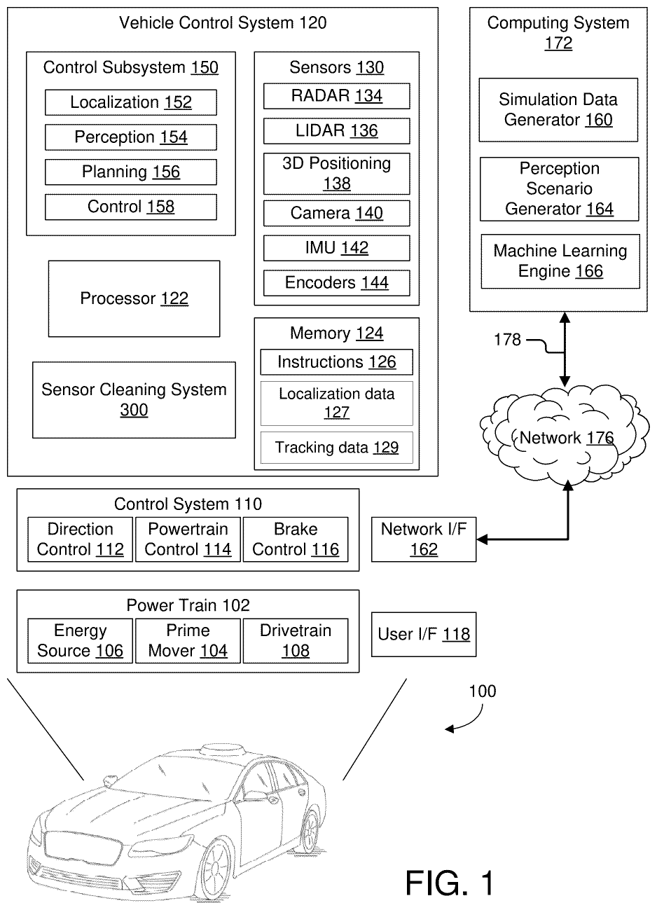

Referring to the drawings, wherein like numbers denote like parts throughout the several views, FIG. 1 illustrates an example hardware and software environment for an autonomous vehicle within which various techniques disclosed herein may be implemented. The vehicle 100, for example, may include a powertrain 102 including a prime mover 104 powered by an energy source 106 and capable of providing power to a drivetrain 108, as well as a control system 110 including a direction control 112, a powertrain control 114, and a brake control 116. The vehicle 100 may be implemented as any number of different types of vehicles, including vehicles capable of transporting people and/or cargo, and capable of traveling by land, by sea, by air, underground, undersea, and/or in space, and it will be appreciated that the aforementioned components 102-116 may vary widely based upon the type of vehicle within which these components are utilized.

For simplicity, the implementations discussed hereinafter will focus on a wheeled land vehicle such as a car, van, truck, bus, etc. In such implementations, the prime mover 104 may include one or more electric motors and/or an internal combustion engine (among others). The energy source 106 may include, for example, a fuel system (e.g., providing gasoline, diesel, hydrogen, etc.), a battery system, solar panels, or other renewable energy sources, and/or a fuel cell system. The drivetrain 108 includes wheels and/or tires along with a transmission and/or any other mechanical drive components suitable for converting the output of the prime mover 104 into vehicular motion, as well as one or more brakes configured to controllably stop or slow the vehicle 100 and direction or steering components suitable for controlling the trajectory of the vehicle 100 (e.g., a rack and pinion steering linkage enabling one or more wheels of the vehicle 100 to pivot about a generally vertical axis to vary an angle of the rotational planes of the wheels relative to the longitudinal axis of the vehicle). In some implementations, combinations of powertrains and energy sources may be used (e.g., in the case of electric/gas hybrid vehicles), and in some implementations, multiple electric motors (e.g., dedicated to individual wheels or axles) may be used as a prime mover. In the case of a hydrogen fuel cell implementation, the prime mover 104 may include one or more electric motors and the energy source 106 may include a fuel cell system powered by hydrogen fuel.

The direction control 112 may include one or more actuators and/or sensors for controlling and receiving feedback from the direction or steering components to enable the vehicle 100 to follow a desired trajectory. The powertrain control 114 may be configured to control the output of the powertrain 102, e.g., to control the output power of the prime mover 104, to control a gear of a transmission in the drivetrain 108, etc., thereby controlling a speed and/or direction of the vehicle 100. The brake control 116 may be configured to control one or more brakes that slow or stop vehicle 100, e.g., disk or drum brakes coupled to the wheels of the vehicle.

Other vehicle types, including but not limited to airplanes, space vehicles, helicopters, drones, military vehicles, all-terrain or tracked vehicles, ships, submarines, construction equipment etc., will necessarily utilize different powertrains, drivetrains, energy sources, direction controls, powertrain controls and brake controls. Moreover, in some implementations, some of the components can be combined, e.g., where directional control of a vehicle is primarily handled by varying an output of one or more prime movers. Therefore, implementations disclosed herein are not limited to the particular application of the herein-described techniques in an autonomous wheeled land vehicle.

In the illustrated implementation, full or semi-autonomous control over the vehicle 100 is implemented in a vehicle control system 120, which may include one or more processors 122 and one or more memories 124, with each processor 122 configured to execute program code instructions 126 stored in a memory 124. The processors(s) can include, for example, graphics processing unit(s) (“GPU(s)”)) and/or central processing unit(s) (“CPU(s)”).

Sensors 130 may include various sensors suitable for collecting information from a vehicle's surrounding environment for use in controlling the operation of the vehicle 100. For example, sensors 130 can include RADAR sensor 134, LIDAR (Light Detection and Ranging) sensor 136, a 3D positioning sensor 138, e.g., a satellite navigation system such as GPS (Global Positioning System), GLONASS (Globalnaya Navigazionnaya Sputnikovaya Sistema, or Global Navigation Satellite System), BeiDou Navigation Satellite System (BDS), Galileo, Compass, etc. The 3D positioning sensors 138 can be used to determine the location of the vehicle on the Earth using satellite signals. The sensors 130 can optionally include a camera 140 and/or an IMU (inertial measurement unit) 142. The camera 140 can be a monographic or stereographic camera and can record still and/or video images. The IMU 142 can include multiple gyroscopes and accelerometers capable of detecting linear and rotational motion of the vehicle 100 in three directions. One or more encoders 144, such as wheel encoders may be used to monitor the rotation of one or more wheels of vehicle 100.

The vehicle control system 120 may also be operatively coupled to a sensor cleaning system 300 that will be described in further detail below. The sensor cleaning system 300 provides for detection of a condition of a sensor relative to a nominally operating sensor and can initiate one or more cleaning cycles.

The outputs of sensors 130 may be provided to a set of control subsystems 150, including, a localization subsystem 152, a perception subsystem 154, a planning subsystem 156, and a control subsystem 158. The localization subsystem 152 is principally responsible for precisely determining the location and orientation (also sometimes referred to as “pose”) of the vehicle 100 within its surrounding environment, and within some frame of reference. The perception subsystem 154 is principally responsible for detecting, tracking, and/or identifying objects within the environment surrounding vehicle 100. A machine learning model in accordance with some implementations can be utilized in tracking objects. The planning subsystem 156 is principally responsible for planning a trajectory or a path of motion for vehicle 100 over some timeframe given a desired destination as well as the static and moving objects within the environment. A machine learning model in accordance with some implementations can be utilized in planning a vehicle trajectory. The control subsystem 158 is principally responsible for generating suitable control signals for controlling the various controls in the vehicle control system 120 in order to implement the planned trajectory of vehicle 100. Similarly, a machine learning model can be utilized to generate one or more signals to control the autonomous vehicle 100 to implement the planned trajectory.

It will be appreciated that the collection of components illustrated in FIG. 1 for the vehicle control system 120 is merely one example. Individual sensors may be omitted in some implementations. Additionally, or alternatively, in some implementations, multiple sensors of the same types illustrated in FIG. 1 may be used for redundancy and/or to cover different regions around a vehicle. Moreover, there may be additional sensors beyond those described above to provide actual sensor data related to the operation and environment of the wheeled land vehicle. Likewise, different types and/or combinations of control subsystems may be used in other implementations. Further, while subsystems 152-158 are illustrated as being separate from processor 122 and memory 124, it will be appreciated that in some implementations, some or all of the functionality of a subsystem 152-158 may be implemented with program code instructions 126 resident in one or more memories 124 and executed by one or more processors 122, and that these subsystems 152-158 may in some instances be implemented using the same processor(s) and/or memory. Subsystems may be implemented at least in part using various dedicated circuit logic, various processors, various field programmable gate arrays (“FPGA”), various application-specific integrated circuits (“ASIC”), various real time controllers, and the like, as noted above, multiple subsystems may utilize circuitry, processors, sensors, and/or other components. Further, the various components in the vehicle control system 120 may be networked in various manners.

In some implementations, the vehicle 100 may also include a secondary vehicle control system (not illustrated), which may be used as a redundant or backup control system for the vehicle 100. In some implementations, the secondary vehicle control system may be capable of fully operating the autonomous vehicle 100 in the event of an adverse event in the vehicle control system 120, while in other implementations, the secondary vehicle control system may only have limited functionality, e.g., to perform a controlled stop of the vehicle 100 in response to an adverse event detected in the primary vehicle control system 120. In still other implementations, the secondary vehicle control system may be omitted.

In general, an innumerable number of different architectures, including various combinations of software, hardware, circuit logic, sensors, networks, etc. may be used to implement the various components illustrated in FIG. 1. Each processor 122 may be implemented, for example, as a microprocessor and each memory may represent the random-access memory (“RAM”) devices comprising a main storage, as well as any supplemental levels of memory, e.g., cache memories, non-volatile or backup memories (e.g., programmable or flash memories), read-only memories, etc. In addition, each memory may be considered to include memory storage physically located elsewhere in the vehicle 100, e.g., any cache memory in a processor, as well as any storage capacity used as a virtual memory, e.g., as stored on a mass storage device or another computer controller. One or more processors 122 illustrated in FIG. 1, or entirely separate processors, may be used to implement additional functionality in the vehicle 100 outside of the purposes of autonomous control, e.g., to control entertainment systems, to operate doors, lights, convenience features, etc.

In addition, for additional storage, the vehicle 100 may include one or more mass storage devices, e.g., a removable disk drive, a hard disk drive, a direct access storage device (“DASD”), an optical drive (e.g., a CD drive, a DVD drive, etc.), a solid-state storage drive (“SSD”), network attached storage, a storage area network, and/or a tape drive, among others.

Furthermore, the vehicle 100 may include a user interface 164 to enable vehicle 100 to receive a number of inputs from and generate outputs for a user or operator, e.g., one or more displays, touchscreens, voice and/or gesture interfaces, buttons, and other tactile controls, etc. Otherwise, user input may be received via another computer or electronic device, e.g., via an app on a mobile device or via a web interface.

Moreover, the vehicle 100 may include one or more network interfaces, e.g., network interface 162, suitable for communicating with one or more networks 176 to permit the communication of information with other computers and electronic devices, including, for example, a central service, such as a cloud service, from which the vehicle 100 receives information including trained machine learning models and other data for use in autonomous control thereof. The one or more networks 176, for example, may be a communication network that includes a wide area network (“WAN”) such as the Internet, one or more local area networks (“LANs”) such as Wi-Fi LANs, mesh networks, etc., and one or more bus subsystems. The one or more networks 176 may optionally utilize one or more standard communication technologies, protocols, and/or inter-process communication techniques. In some implementations, data collected by the one or more sensors 130 can be uploaded to a remote data center 160, that may include a computing system (not illustrated) via the network 176 for additional processing.

In the illustrated implementation, the vehicle 100 may communicate via the network 176 with a remote data center 160 for the purposes of implementing various functions described below.

Each processor 122 illustrated in FIG. 1, as well as various additional controllers and subsystems disclosed herein, operates under the control of an operating system and executes or otherwise relies upon various computer software applications, components, programs, objects, modules, data structures, etc., as will be described in greater detail below. Moreover, various applications, components, programs, objects, modules, etc. may also execute on one or more processors in another computer (e.g., computing system 172) coupled to vehicle 100 via network 176, e.g., in a distributed, cloud-based, or client-server computing environment, whereby the processing required to implement the functions of a computer program may be allocated to multiple computers and/or services over a network.

In general, the routines executed to implement the various implementations described herein, whether implemented as part of an operating system or a specific application, component, program, object, module, or sequence of instructions, or even a subset thereof, will be referred to herein as “program code.” Program code typically comprises one or more instructions that are resident at various times in various memory and storage devices, and that, when read and executed by one or more processors, perform the steps necessary to execute steps or elements embodying the various aspects of the present disclosure. Moreover, while implementations have and hereinafter will be described in the context of fully functioning computers and systems, it will be appreciated that the various implementations described herein are capable of being distributed as a program product in a variety of forms, and that implementations can be implemented regardless of the particular type of computer readable media used to actually carry out the distribution.

Examples of computer readable media include tangible, non-transitory media such as volatile and non-volatile memory devices, floppy and other removable disks, solid state drives, hard disk drives, magnetic tape, and optical disks (e.g., CD-ROMs, DVDs, etc.) among others.

In addition, various program codes described hereinafter may be identified based upon the application within which it is implemented in a specific implementation. However, it should be appreciated that any particular program nomenclature that follows is used merely for convenience, and thus the present disclosure should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the present disclosure is not limited to the specific organization and allocation of program functionality described herein.

The example environment illustrated in FIG. 1 is not intended to limit implementations disclosed herein. Indeed, other alternative hardware and/or software environments may be used without departing from the scope of implementations disclosed herein.

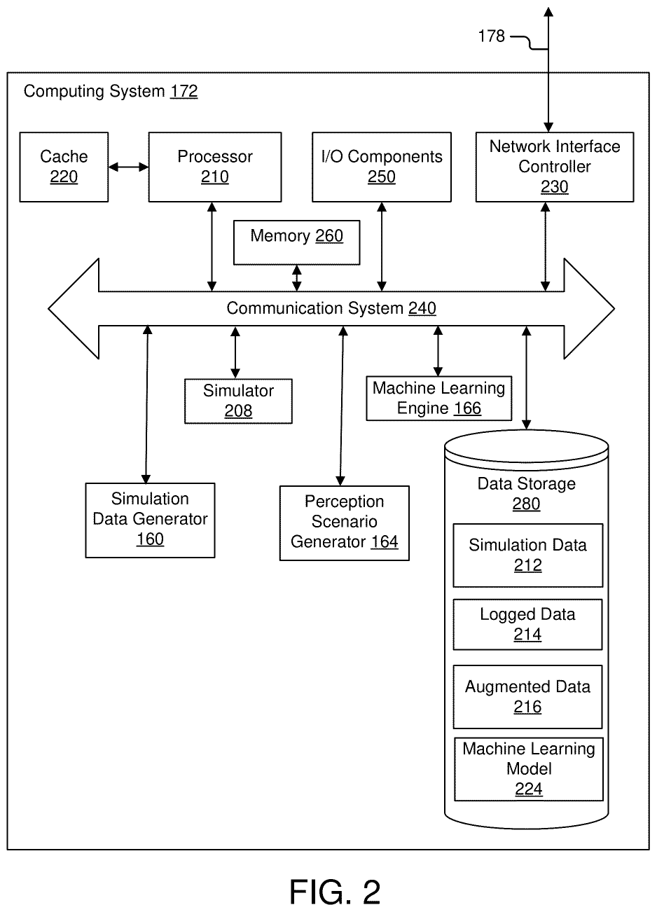

FIG. 2 is a block diagram illustrating an example of a remote data center 160 for concurrently interfacing with and perform aspects of the method for cleaning a sensor according to some implementations.

Referring to FIG. 2, the illustrated example the vehicle control system 120 includes one or more processors 210 in communication, via a communication system 240 (e.g., bus), with memory 260, at least one network interface controller 230 with network interface port for connection to a network (e.g., network 176 via signal line 178), a data storage 280, and other components, e.g., an input/output (“I/O”) components interface 250 connecting to a display (not illustrated) and an input device (not illustrated). The processor(s) 210 will execute instructions (or computer programs) received from memory 260. The processor(s) 210 illustrated incorporate, or are directly connected to, cache memory 220. In some instances, instructions are read from memory 260 into the cache memory 220 and executed by the processor(s) 210 from the cache memory 220.

In more detail, the processor(s) 210 may be any logic circuitry that processes instructions, e.g., instructions fetched from the memory 260 or cache 220. In some implementations, the processor(s) 210 are microprocessor units or special purpose processors. The vehicle control system 120 may be based on any processor, or set of processors, capable of operating as described herein. The processor(s) 210 may be a single core or multi-core processor(s). The processor(s) 210 may be multiple distinct processors.

The memory 260 may be any device suitable for storing computer readable data. The memory 260 may be a device with fixed storage or a device for reading removable storage media. Examples include all forms of non-volatile memory, media and memory devices, semiconductor memory devices (e.g., EPROM, EEPROM, SDRAM, and flash memory devices), magnetic disks, magneto optical disks, and optical discs (e.g., CD ROM, DVD-ROM, or Blu-Ray® discs). The vehicle control system 120 may have any number of memory devices as the memory 260.

The cache memory 220 is a form of computer memory placed in close proximity to the processor(s) 210 for fast read times. In some implementations, the cache memory 220 is part of, or on the same chip as, the processor(s) 210. In some implementations, there are multiple levels of cache 220, e.g., L2 and L3 cache layers.

The network interface controller 230 manages data exchanges via the network interface (sometimes referred to as network interface ports). The network interface controller 230 handles the physical and data link layers for network communication. In some implementations, some of the network interface controller's tasks are handled by one or more of the processors 210. In some implementations, the network interface controller 230 is part of a processor 210. In some implementations, the vehicle control system 120 has multiple network interfaces controlled by a single controller 230. In some implementations, the vehicle control system 120 has multiple network interface controllers 230. In some implementations, each network interface is a connection point for a physical network link (e.g., a cat-5 Ethernet link). In some implementations, the network interface controller 230 supports wireless network connections and an interface port is a wireless (e.g., radio) receiver/transmitter (e.g., for any of the IEEE 802.11 protocols, near field communication “NFC”, Bluetooth, ANT, WiMAX, 5G, or any other wireless protocol). In some implementations, the network interface controller 230 implements one or more network protocols such as Ethernet. The vehicle control system 120 exchanges data with other computing devices via physical or wireless links (represented by signal line 178) through a network interface. The network interface may link directly to another device or to another device via an intermediary device, e.g., a network device such as a hub, a bridge, a switch, or a router, the vehicle control system 120 to a data network such as the Internet.

The data storage 280 may be a non-transitory storage device that stores data for providing the functionality described herein. The data storage 280 may store, among other data, including code keys, sensor data, and any other data.

The vehicle control system 120 may include, or provide interfaces for, one or more input or output (“I/O”) devices 250. Input devices include, without limitation, keyboards, microphones, touch screens, foot pedals, sensors, MIDI devices, and pointing devices such as a mouse or trackball. Output devices include, without limitation, video displays, speakers, refreshable Braille terminal, lights, MIDI devices, and 2-D or 3-D printers. Other components may include an I/O interface, external serial device ports, and any additional co-processors. For example, a computing system 172 may include an interface (e.g., a universal serial bus (USB) interface) for connecting input devices, output devices, or additional memory devices (e.g., portable flash drive or external media drive). In some implementations, the vehicle control system 120 includes an additional device such as a co-processor, e.g., a math co-processor can assist the processor 210 with high precision or complex calculations.

### Sensor Cleaning System

As discussed above, vehicles, and in particular autonomous vehicles that may (or may not) lack of a driver, may need to occasionally clean one or more sensors while the vehicle is operating or traveling along a road.

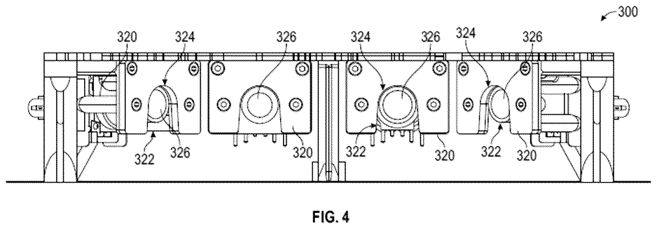

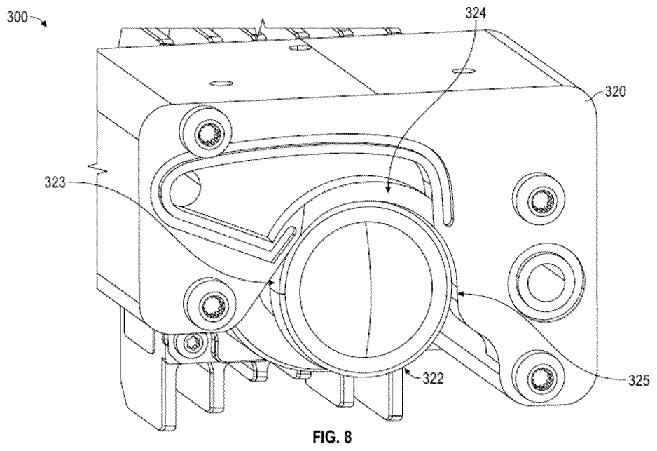

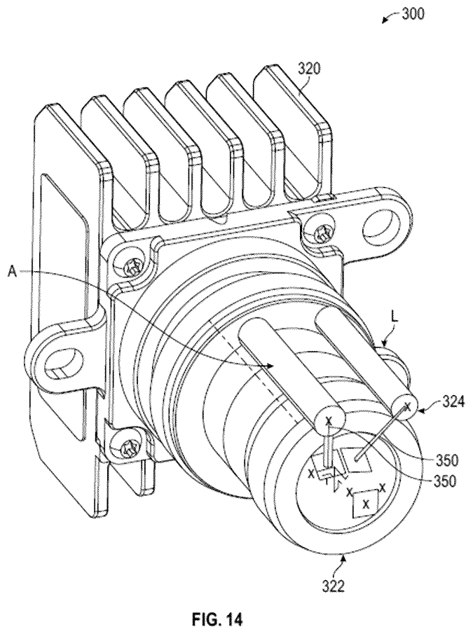

The vehicle control system 120 may be operably coupled to a sensor cleaning system 300 that may include one or more of the components as illustrated in FIGS. 4-15, where common numbers illustrate common features. The sensors illustrated and discussed below may be attached to a vehicle internally, externally, in a housing, or in any other manner as known.

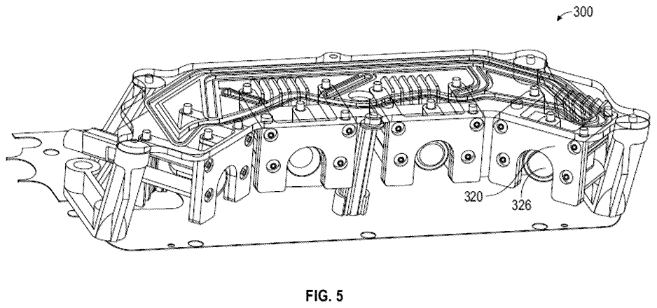

Referring now to FIG. 4, a sensor cleaning system 300 for use on an autonomous vehicle 100 includes at least one sensor 320 configured to generate a sensor signal. FIG. 4 shows a front view of the sensor cleaning system 300 and FIG. 5 shows a perspective view of the sensor cleaning system 300 according to some implementations. The at least one sensor 320 may be communicatively coupled to the processor 122 (See FIG. 1) to transmit a sensor signal to the processor 122 and to receive operational signals from the processor 122.

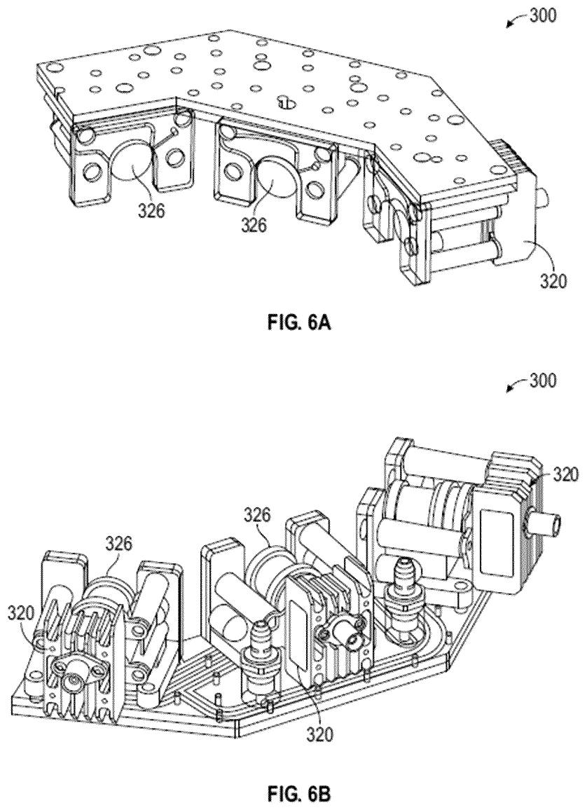

Another implementation of the sensor cleaning system 300 is shown in FIGS. 6A and 6B. In this implementation, the sensor cleaning system 300 comprises three (3) sensors 320 as opposed to FIGS. 4 and 5 that have four (4) sensors 320.

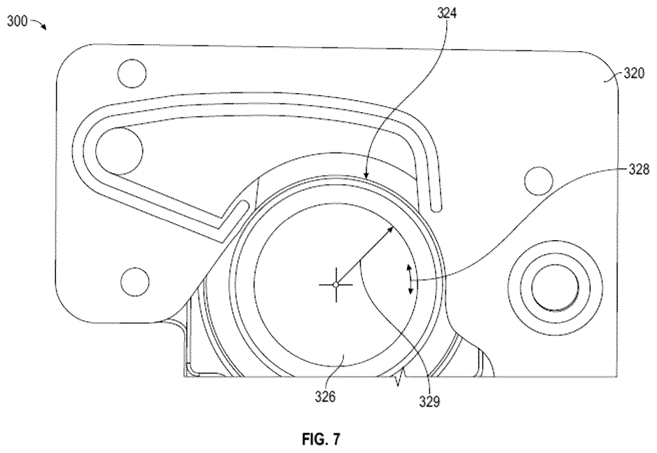

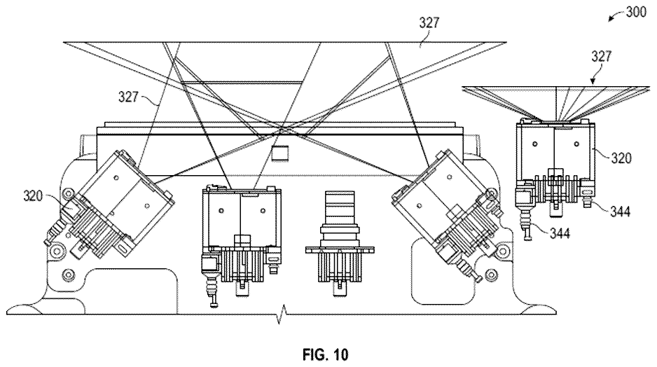

As shown in FIGS. 7, 8 and 9, the at least one sensor 320 may include a sensor bottom 322, a sensor top 324, a sensor left side 323, a sensor right side 325 spaced apart from the sensor left side 323, and at least one sensor lens 326 configured to provide a field of view 327 (FIG. 10) extending away from an exterior of the autonomous vehicle 100. The at least one sensor lens 326 includes a circumference 328 and a radius of curvature 329.

The at least one sensor lens 326 may include a plurality of sensor lenses, whether placed in parallel (e.g., adjacent lenses) or serially (e.g., stacked lens). The at least one lens 326 may be made of any material that is at least semi-transparent or fully transparent to light (visible and/or infrared), acoustic, or electromagnetic (e.g., radio frequencies, such as those used in radar sensors) signals and wavelengths. The at least one sensor lens 326 may be manufactured of glass, plastic, and other similar materials.

The at least one sensor lens 326 may be of any shape, including square, rectangular, circular, oval, round, concave, convex, spherical, hemi-spherical, oval/ovoid, and the like.

The at least one sensor 320 may be one of a light detection and ranging (lidar) sensor and a radio detection and ranging (radar) sensor, a visual camera, a wide-angle view camera sensor (visual or infrared), a fish-eye camera sensor, an infrared camera sensor, a sonar or echo-location sensor, and the like. The at least one sensor 320 may provide about at least a 180-degree field of view, a 360-degree field of view, a 120-degree field of view, a 90-degree field of view, a 60-degree field of view, a 45-degree field of view, or any subset above and below these ranges. “About” in this instance is considered to be plus or minus 10 percent of the maximum angle of a given range.

The sensor cleaning system 320 also includes at least one reservoir 340 for a fluid, which may be a liquid or a gas. Optionally, the gas may be at a pressure above atmospheric pressure. The gas may be air or any combination, mixture, or single gas. The liquid may be water, alcohol, washer fluid, combinations thereof, or any other liquid. The at least one reservoir 340 may include a plurality of reservoirs. Each reservoir 340 of the plurality of reservoirs may contain a different fluid from the other reservoir 340 of the plurality of reservoirs. For example, one reservoir 340 may have a liquid and the other reservoir 340 may have a gas.

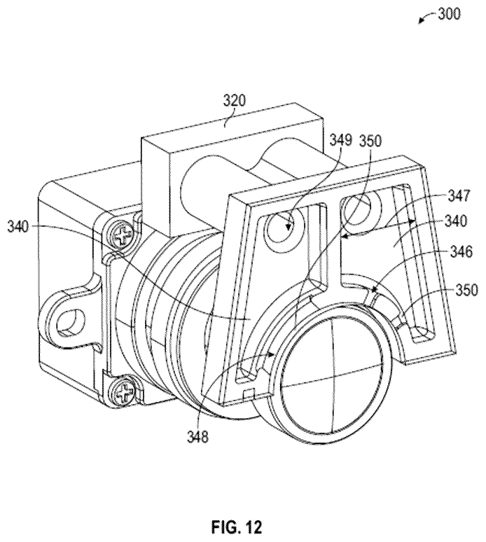

Referring now to FIG. 12, implementation of the conduit 342 according to some implementations is shown. At least one conduit 342 may be fluidly coupled to the at least one reservoir 340 and to at least one nozzle 350 configured to direct the fluid towards the at least one sensor lens 321. The at least one conduit may be contiguous/unitary from the at least one reservoir 340 to the at least one nozzle 350, or it may include one or more couplings 344 that join different portions of the at least one conduit 342. The coupling 344 may be of any time, including barbed, threaded, quick connect, snap fit, and other such connectors or couplings. The conduit 342 may include at least one plenum 346 adjacent the at least one nozzle 350. The at least one plenum 346 may have a dimension 347, such as a width, diameter, or other similar dimension, that increases from a first portion 348 adjacent to the at least one nozzle 350 to a second portion 349 spaced apart from the first portion 348. The change in the dimension 347 may help increase the fluid velocity of a fluid as it passes through the at least one conduit 342 towards and out of the at least one nozzle 350.

The at least one nozzle 350 may include a plurality of nozzles. The plurality of nozzles 350 may extend approximately 45 degrees, 60 degrees, 90 degrees, or 180 degrees around the at least one sensor lens 321. The plurality of nozzles 350 may be contiguously or evenly distributed about the at least one sensor lens 321 (e.g., at about every 15 degrees, 25 degrees, 45, degrees, 60 degrees, 90 degrees, 120 degrees, 180 degrees, and the like.) “About” in this instance is considered to be plus or minus 10 percent of the maximum angle of a given range.

The at least one nozzle 350 may be positioned proximate at least one of the sensor bottom 322, the sensor top 324, the sensor left side 323, and the sensor right side 325. The at least one nozzle or the plurality of nozzles 350 may extend approximately 45 degrees, 60 degrees, 90 degrees, or 180 degrees around the sensor face 326. The plurality of nozzles 350 may be contiguously or evenly distributed about the sensor face 326 (e.g., at about every 15 degrees, 25 degrees, 45, degrees, 60 degrees, 90 degrees, 120 degrees, 180 degrees, and the like.) “About” in this instance is considered to be plus or minus 10 percent of the maximum angle of a given range.

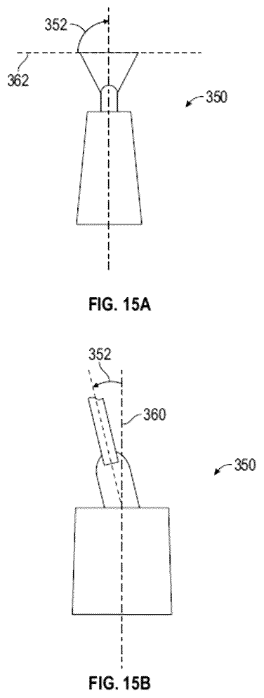

Referring now to FIGS. 15A and 15B, example nozzle angles 252 of the nozzles are shown. The at least one nozzle 350 may include a nozzle angle 352, where the nozzle angle 352 may be measured relative to a vertical axis 360 and relative to a horizontal axis 362, and where the nozzle angle 352 is at least one of a) tilted away from the vertical axis and towards the at least one sensor lens 321 and b) tilted towards the horizontal axis 362. The nozzle angle 352 may be tilted away from the vertical axis 360 from about 0 to 5 degrees, 0 to 10 degrees, 0 to 15 degrees, 0 to 20 degrees, 0 to 30 degrees, 0 to 45 degrees, and 0 to 60 degrees, or at any fixed point (e.g., 3 degrees, 5 degrees, 7.5 degrees, 10 degrees, 15 degrees, 20 degrees, 45 degrees) within those ranges. “About” in this instance is considered to be plus or minus 10 percent of the maximum angle of a given range. The fluid may be ejected from the at least one nozzle 350 at a selected pressure, which is a function of a flow rate of the fluid and the geometry of the nozzle. The pressure may be from about 0 to 100 pounds per square inch (psi), 0 to 80 psi, 0 to 50 psi, 0 to 35 psi, 0 to 20 psi, and 0 to 10 psi, or at any pressure (e.g., 3 psi, 5 psi, 10 psi, 20 psi, 35 psi, 50 psi, and 80 psi) within those ranges. “About” in this instance is considered to be plus or minus 10 percent of the maximum pressure of a given range. Alternatively, the fluid velocity of the fluid exiting the at least one nozzle 350 may be any velocity. For example, it may be any velocity from about 0 meters per second (mps) to about 100 mps; 0 mps to about 80 mps; 0 mps to about 50 mps; 0 mps to about 30 mps; 10 mps to about 80 mps, and the like. “About” in this instance is considered to be plus or minus 10 percent of the maximum velocity of a given range.

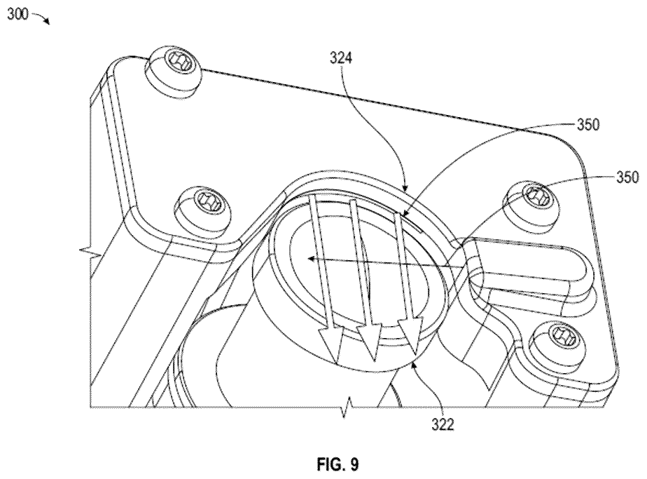

The at least one nozzle 350 may include an exit, or have a nozzle geometry, with a shape of one of a circle, a slot, a square, a rectangle, and an oval. As mentioned, the at least one nozzle 350 may be positioned proximate at least one of the sensor bottom 322 (not illustrated), the sensor top 324 (FIGS. 4 through 9 and 11 through 14), and at least one of the sensor left side 323 (not illustrated) and the sensor right side 325 (FIG. 9). Proximate in this sense may be 20 percent of a quarter (i.e., 90 degrees) that comprise the circumference 328 of the sensor lens 326.

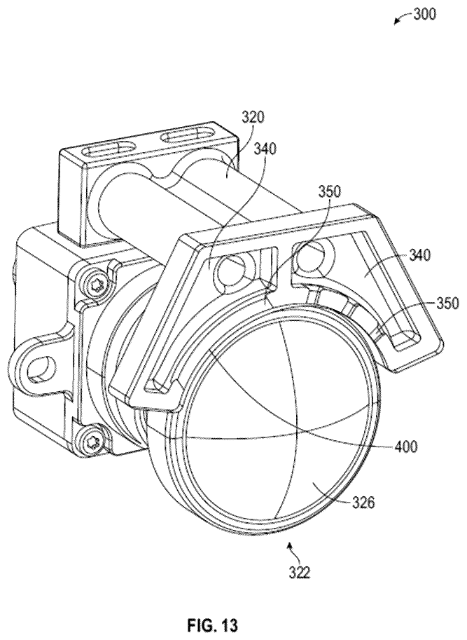

Referring now to FIG. 13, a perspective view of the sensor cleaning system 300 with a self-sealing element 400 according to some implementations is shown. The at least one nozzle 350 optionally includes a self-sealing element 400 that is configured to selectively open upon being impinged by the fluid as it passes through the at least one conduit 342 and/or the at least one plenum 346 and exits the at least one nozzle 350. The self-sealing element 400 may help prevent dirty fluid, debris, dirt, contaminants, other fluid, and the like from entering the at least one nozzle 350 and/or passing into the at least one conduit 342 and/or the at least one plenum 346. The self-sealing element 400 may be a hinged door or slat, a flexible element, such as one or more pieces of rubber, elastomer, or other flexible material, and the like.

The at least one conduit 342 may include a plurality of conduits, where the at least one nozzle 350 may include a plurality of nozzles, and where a first conduit 342 of the plurality of conduits is fluidly coupled to a first reservoir 340 of the plurality of reservoirs and to a first nozzle 350 of the plurality of nozzles and a second conduit 342 of the plurality of the conduits is fluidly coupled to a second reservoir 340 of the plurality of reservoirs and to a second nozzle 350 of the plurality of nozzles.

As shown in FIG. 10, some implementations of the sensor cleaning system 300 may include a plurality of cleaning systems 320 with each of the at least one cleaning systems 320 having a different field of view 327. For example, FIG. 10 illustrates an implementation with four (4) cleaning systems 320 each having a different field of view 327. In this example, three (3) of the cleaning systems 320 having partially overlapping fields of view.

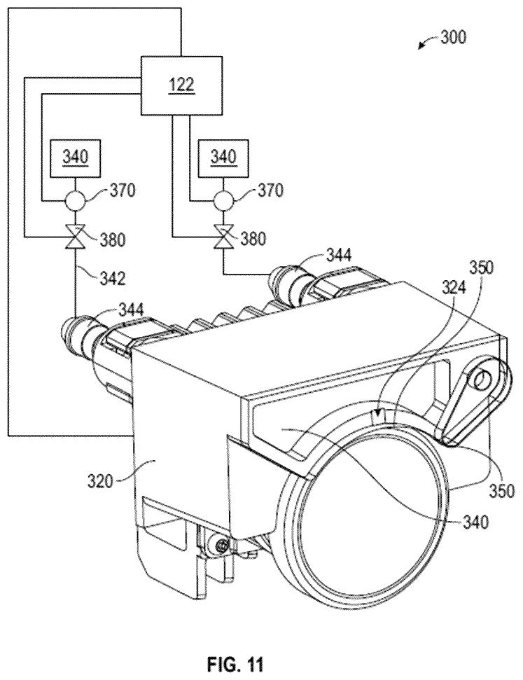

Referring now to FIG. 11, the at least one cleaning system 320 may include at least one pump 370 fluidly coupled to the at least one reservoir 340 and the at least one conduit 342, the at least one pump 342 being communicatively coupled to the at least one processor 122. The at least one pump 370 may include a plurality of pumps such as, for example, a plurality of pumps 370 for a single reservoir 340 and/or a pump 370 for each reservoir 340 of a plurality of reservoirs. The at least one pump 370 may be any time of electrical, electro-mechanical, or other similar pump for dispensing fluids from a reservoir 340.

The at least one cleaning system 320 may include at least one valve 380 fluidly coupled to the at least one reservoir 340 and the at least one conduit 342, the at least one valve 380 being communicatively coupled to the at least one processor 122. The at least one valve 380 may include a plurality of valves such as, for example, a plurality of valves 380 for a single reservoir 340 or conduit 342 and/or a valve 380 for each reservoir 340 of a plurality of reservoirs. The at least one valve 380 may be any time of electrical, electro-mechanical, or other similar valve for opening and closing a conduit to enable or prevent the flow of through a conduit 342.

The at least one processor 122 is communicatively coupled to the at least one sensor 320, typically electrically via wires although wireless connections are also possible. A memory 124 is operably coupled with the at least one processor 122, where the memory 124 stores instructions that, in response to execution of the instructions by the at least one processor 122, cause the at least one processor 122 to perform operations including: receiving the sensor signal from the at least one sensor 320; comparing a detected quality of the sensor signal relative to a nominal quality of the sensor signal; and, dispensing the fluid from the at least one reservoir 340 through the at least one nozzle 350 towards the at least one sensor lens 326. Optionally, in addition to or as an alternative to the at least one processor 122 and the memory 124 to which the at least one sensor 320 is directly and/or indirectly communicatively coupled, the sensor cleaning system 300 may be communicatively coupled, directly or indirectly, to one or more of the simulation data generator 160, the perception scenario generator 164, the machine learning engine 166, the network I/F 162, and the like which may receive and/or transmit data to the sensor cleaning system 300 and receive and/or transmit various instructions related to the various operations performed by the sensor cleaning system 300, including instructions that adapt based on conditions and/or learned outcomes from the machine learning engine 166 and/or any operative model, for example.

For example, a nominal quality of the sensor signal might be one in which environmental conditions are clear and there are no obstructions, such as dirt, snow, rain, or debris, structural defects (e.g., cracks in a lens) in the sensor cleaning system 300, and the like obstructing partially or fully the at least one sensor lens 326. If a nominal quality of a sensor signal is considered approximately 80 to 100 percent of the strength (e.g., analog or digital quality, waveform, data points per unit of measure and so forth) of an entirely obstructed view, the processor 122 might dispense the fluid at any detected quality less than or equal to 80 percent. This is of course just an example and these parameters for nominal quality and detected quality can be set for given conditions. For example, the sensitivity (i.e., the detected quality at which point the processor 122 dispenses a fluid) may be a function of a speed of the vehicle, the weather conditions, and the like. For example, the processor may dispense the fluid more frequently as the vehicle speed increases or as a function of the weather (e.g., dispensing more often in freezing/snowing/sleeting conditions).

The memory 124 optionally may store instructions that, in response to execution of the instructions by the at least one processor 122, cause the at least one processor 122 to perform operations including: generating and transmitting a pump signal to the at least one pump 370; and, actuating the at least one pump 370 to dispense a fluid from the at least one reservoir 340 through the at least one conduit 342. The memory 124 may store instructions that, in response to execution of the instructions by the at least one processor 122, cause the at least one processor 122 to perform operations including: generating and transmitting a valve signal to the at least one valve 380; and, actuating the at least one valve 380 to open or close the at least one valve 380.

Other implementations of one or more of these aspects include corresponding systems, apparatus, and computer programs, configured to perform the actions of the methods, encoded on computer storage devices.

A vehicle 100 may include any one or more of the foregoing elements of the sensor cleaning system 300 in any combination as described above. As one example, a vehicle 100 may include a power train or prime mover 104; at least one sensor 320 configured to generate a sensor signal. The at least one sensor 320 may include a sensor bottom 322, a sensor top 324, a sensor left side 323, a sensor right side 325 spaced apart from the sensor left side 323, and at least one sensor lens 326.

The vehicle 100 may also include at least one reservoir 340 for a fluid; at least one conduit 342 fluidly coupled to the at least one reservoir 340 and to at least one nozzle 350 configured to direct the fluid towards the at least one sensor lens 326; and a vehicle control system 120 that may include: at least one processor 122 communicatively coupled to the at least one sensor 320; and, a memory 124 operably coupled with the at least one processor 122, where the memory 124 stores instructions that, in response to execution of the instructions by the at least one processor 122, cause the at least one processor 122 to perform operations including: receiving the sensor signal from the at least one sensor 320; comparing a detected quality of the sensor signal relative to a nominal quality of the sensor signal; and, dispensing the fluid from the at least one reservoir 340 through the at least one nozzle 350 towards the at least one sensor lens 326.

Optionally, the vehicle control system 120 may provide one of full control and semi-autonomous control over the vehicle 100. The vehicle 100 may be a truck. The vehicle 100 may be an autonomous vehicle.

A vehicle control system 120 for a vehicle 100 may include any one or more of the foregoing elements of the sensor cleaning system 300 in any combination as described above. As one example, a vehicle control system 120 for a vehicle 100 may include a sensor cleaning system 300 with at least one sensor 320 configured to generate a sensor signal. The at least one sensor 320 may include a sensor bottom 322, a sensor top 324, a sensor left side 323, a sensor right side 325 spaced apart from the sensor left side 323, and at least one sensor lens 326.

The vehicle control system 120 also includes at least one reservoir 340 for a fluid; at least one conduit 342 fluidly coupled to the at least one reservoir 340 and to at least one nozzle 350 configured to a direct the fluid towards the at least one sensor lens 326; at least one processor 122 communicatively coupled to the at least one sensor 320; and, a memory 124 operably coupled with the at least one processor 122, where the memory 124 stores instructions that, in response to execution of the instructions by the at least one processor 122, cause the at least one processor 122 to perform operations including: receiving the sensor signal from the at least one sensor 320; comparing a detected quality of the sensor signal relative to a nominal quality of the sensor signal; and, dispensing the fluid from the at least one reservoir 340 through the at least one nozzle 350 towards the at least one sensor lens 326.

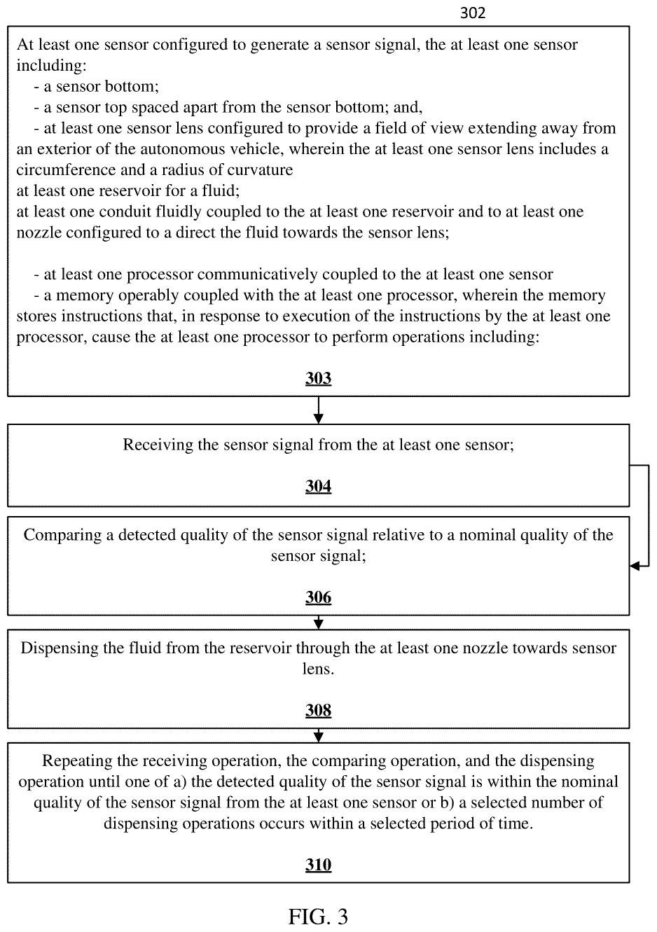

Referring back to FIG. 3, a method 302 of cleaning at least one sensor 320 may be implemented at step 303 by the sensor cleaning system 300 and/or the vehicle control system 120 as described above and below. The method 302 may include at least one sensor 320 configured to generate a sensor signal. The at least one sensor 320 may include a sensor bottom 322, a sensor top 324, a sensor left side 323, a sensor right side 325 spaced apart from the sensor left side 323, and at least one sensor lens 326. The method 302 may also include at least one reservoir 340 for a fluid; at least one conduit 342 fluidly coupled to the at least one reservoir 340 and to at least one nozzle 350 configured to direct the fluid towards the at least one sensor lens 326. The method 302 may also include a vehicle control system 120 that includes: at least one processor 122 communicatively coupled to the at least one sensor 320; and, a memory 124 operably coupled with the at least one processor 122, where the memory 124 stores instructions that, in response to execution of the instructions by the at least one processor 122, cause the at least one processor 122 to perform one or more of the following operations implemented in any order, including: receiving the sensor signal from the at least one sensor 304; comparing a detected quality of the sensor signal relative to a nominal quality of the sensor signal 306; and, dispensing the fluid from the reservoir through the at least one nozzle towards the at least one sensor lens 326.

The method may also include repeating the receiving operation, the comparing operation, and the dispensing operation until one of a) the detected quality of the sensor signal is within the nominal quality of the sensor signal from the at least one sensor or b) a selected number of dispensing operations occurs within a selected period of time 310.

The previous description is provided to enable practice of the various aspects described herein. Various modifications to these aspects will be understood, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout the previous description that are known or later come to be known are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of blocks in the processes disclosed is an example of illustrative approaches. Based upon design preferences, it is understood that the specific order or hierarchy of blocks in the processes may be rearranged while remaining within the scope of the previous description. The accompanying method claims present elements of the various blocks in a sample order and are not meant to be limited to the specific order or hierarchy presented.

The previous description of the disclosed implementations is provided to enable others to make or use the disclosed subject matter. Various modifications to these implementations will be readily apparent, and the generic principles defined herein may be applied to other implementations without departing from the spirit or scope of the previous description. Thus, the previous description is not intended to be limited to the implementations shown herein but is to be accorded the widest scope consistent with the principles and novel features disclosed herein.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example.

The foregoing method descriptions and the process flow diagrams are provided merely as illustrative examples and are not intended to require or imply that the blocks of various examples must be performed in the order presented. As will be appreciated, the order of blocks in the foregoing examples may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the examples disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the examples disclosed herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In some examples, the functions described may be implemented in hardware, software, firmware, or any combination thereof. If implemented in software, the functions may be stored as one or more instructions or code on a non-transitory computer-readable storage medium or non-transitory processor-readable storage medium. The blocks of a method or algorithm disclosed herein may be implemented in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed examples is provided to enable others to make or use the present disclosure. Various modifications to these examples will be readily apparent, and the generic principles defined herein may be applied to some examples without departing from the spirit or scope of the disclosure. Thus, the present disclosure is not intended to be limited to the examples shown herein but is to be accorded the widest scope consistent with the following claims and the principles and novel features disclosed herein.

What is claimed is:

1. A sensor cleaning system for use on an autonomous vehicle, the sensor cleaning system comprising:
at least one sensor configured to generate a sensor signal, the at least one sensor including:
a sensor bottom;
a sensor top spaced apart from the sensor bottom; and,
at least one sensor lens configured to provide a field of view extending away from an exterior of the autonomous vehicle, wherein the at least one sensor lens includes a circumference and a radius of curvature;
at least one reservoir for a fluid;
at least one conduit fluidly coupled to the at least one reservoir and to at least one nozzle configured to direct the fluid towards the at least one sensor lens;
at least one processor communicatively coupled to the at least one sensor; and,
a memory operably coupled with the at least one processor, wherein the memory stores instructions that, in response to execution of the instructions by the at least one processor, cause the at least one processor to perform operations including:
receiving the sensor signal from the at least one sensor;
comparing a detected quality of the sensor signal relative to a nominal quality of the sensor signal; and,
dispensing the fluid from the at least one reservoir through the at least one nozzle towards the at least one sensor lens.

2. The sensor cleaning system of claim 1, wherein a fluid velocity of the fluid as the fluid exits the at least one nozzle is from about 10 meters per second to about 80 meters per second.

3. The sensor cleaning system of claim 1, wherein the at least one sensor is one of a wide-angle view camera sensor, a camera sensor, a fish-eye camera sensor, and an infrared sensor.

4. The sensor cleaning system of claim 1, wherein the at least one sensor provides at least a 120-degree field of view.

5. The sensor cleaning system of claim 1, wherein the fluid is one of a) a gas at a pressure above atmospheric pressure and b) a liquid.

6. The sensor cleaning system of claim 1, wherein the at least one nozzle includes a nozzle angle, wherein the nozzle angle is measured relative to a vertical axis and relative to a horizontal axis, and wherein the nozzle angle is at least one of a) tilted away from the vertical axis and towards a sensor face and b) tilted towards the horizontal axis.

7. The sensor cleaning system of claim 1, wherein the at least one nozzle includes an exit with a shape of one of a circle, a slot, a square, a rectangle, and an oval.

8. The sensor cleaning system of claim 1, wherein the at least one nozzle is positioned proximate at least one of the sensor bottom and the sensor top.

9. The sensor cleaning system of claim 1, wherein the at least one nozzle extends approximately 180 degrees around the at least one sensor lens.

10. The sensor cleaning system of claim 1, wherein the at least one nozzle includes a plurality of nozzles.

11. The sensor cleaning system of claim 10, wherein a first nozzle of the plurality of nozzles dispenses a liquid and a second nozzle of the plurality of the nozzles dispenses a gas.

12. The sensor cleaning system of claim 1, wherein the at least one reservoir comprises a plurality of reservoirs.

13. The sensor cleaning system of claim 12, wherein the at least one conduit comprises a plurality of conduits, wherein the at least one nozzle comprises a plurality of nozzles, and wherein a first conduit of the plurality of conduits is fluidly coupled to a first reservoir of the plurality of reservoirs and to a first nozzle of the plurality of nozzles and a second conduit of the plurality of the conduits is fluidly coupled to a second reservoir of the plurality of reservoirs and to a second nozzle of the plurality of nozzles.

14. The sensor cleaning system of claim 1, further comprising:
at least one pump fluidly coupled to the at least one reservoir and the at least one conduit, the at least one pump being communicatively coupled to the at least one processor; and,
wherein the memory stores instructions that, in response to execution of the instructions by the at least one processor, cause the at least one processor to perform operations including:
generating and transmitting a pump signal to the at least one pump; and,
actuating the at least one pump.

15. The sensor cleaning system of claim 1, further comprising:
at least one valve fluidly coupled to the at least one reservoir and the at least one conduit, the at least one valve being communicatively coupled to the at least one processor; and,
wherein the memory stores instructions that, in response to execution of the instructions by the at least one processor, cause the at least one processor to perform operations including:
generating and transmitting a valve signal to the at least one valve; and,
actuating the at least one valve.

16. An autonomous vehicle, comprising:
a power train;
at least one sensor configured to generate a sensor signal, the at least one sensor including:
a sensor bottom;
a sensor top spaced apart from the sensor bottom; and,
at least one sensor lens configured to provide a field of view extending away from an exterior of the autonomous vehicle, wherein the at least one sensor lens includes a circumference and a radius of curvature;
at least one conduit fluidly coupled to at least one reservoir and to at least one nozzle configured to direct a fluid towards the at least one sensor lens;
a vehicle control system that includes:
at least one processor communicatively coupled to the at least one sensor; and,
a memory operably coupled with the at least one processor, wherein the memory stores instructions that, in response to execution of the instructions by the at least one processor, cause the at least one processor to perform operations including:
receiving the sensor signal from the at least one sensor;
comparing a detected quality of the sensor signal relative to a nominal quality of the sensor signal; and,
dispensing the fluid from the at least one reservoir through the at least one nozzle towards the at least one sensor lens.

17. The autonomous vehicle of claim 16, wherein the vehicle control system provides one of full control and semi-autonomous control over the vehicle.

18. The autonomous vehicle of claim 16, wherein the vehicle is a truck.

19. A method of cleaning a sensor on an autonomous vehicle, comprising:
at least one sensor configured to generate a sensor signal, the at least one sensor including:
a sensor bottom;
a sensor top spaced apart from the sensor bottom; and,
at least one sensor lens configured to provide a field of view extending away from an exterior of the autonomous vehicle, wherein the at least one sensor lens includes a circumference and a radius of curvature;
at least one reservoir for a fluid;
at least one conduit fluidly coupled to the at least one reservoir and to at least one nozzle configured to direct the fluid towards the at least one sensor lens;
a vehicle control system that includes:
at least one processor communicatively coupled to the at least one sensor; and,
a memory operably coupled with the at least one processor, wherein the memory stores instructions that, in response to execution of the instructions by the at least one processor, cause the at least one processor to perform operations including:
receiving the sensor signal from the at least one sensor;
comparing a detected quality of the sensor signal relative to a nominal quality of the sensor signal; and,
dispensing the fluid from the at least one reservoir through the at least one nozzle towards the at least one sensor lens.

20. The method of claim 19, wherein the memory stores instructions that, in response to execution of the instructions by the at least one processor, cause the at least one processor to perform operations including:
repeating the receiving, the comparing, and the dispensing until one of a) the detected quality of the sensor signal is within the nominal quality of the sensor signal from the at least one sensor or b) a selected number of dispensing operations occurs within a selected period of time.
